(19) United States
(12) Patent Application Publication
(10) Pub. No.: US 2013/0316058 A1
(43) Pub. Date: Nov. 28, 2013

(54) FLAX SUBSTITUTION METHODS AND FOOD PRODUCTS

(71) Applicants: Tammy Crowe, East Windsor, NR (US); Troy Crowe, East Windsor, NJ (US); Mary Ekman, Antioch, IL (US); Glenn Pizzey, Angusville (CA); Linda Pizzey, Angusville (CA)

(72) Inventors: Tammy Crowe, East Windsor, NR (US); Troy Crowe, East Windsor, NJ (US); Mary Ekman, Antioch, IL (US); Glenn Pizzey, Angusville (CA); Linda Pizzey, Angusville (CA)

(21) Appl. No.: 13/957,417

(22) Filed: Aug. 1, 2013

Related U.S. Application Data
(62) Division of application No. 12/562,082, filed on Sep. 17, 2009, now abandoned.
(60) Provisional application No. 61/098,443, filed on Sep. 19, 2008.

(51) Int. Cl. A23L 1/29; A21D 2/38

(52) U.S. Cl. CPC A23L 1/29; A21D 2/38
USPC 426/507

(57) ABSTRACT

Methods of preparing a stable, flax-substituted food product that include the use of a pre-hydrated flaxseed composition to replace, or be used in place of, a fat, hydrocolloid, gluten component, or all three are described. Stable food products including flax components are also described.

### CROSS-REFERENCE TO RELATED APPLICATIONS

This application claims the benefit of U.S. Non-provisional application Ser. No. 12/562,082, filed Sep. 17, 2009, which claimed the benefit of priority of U.S. Provisional Application No. 61/098,443, filed on Sep. 19, 2008, both of which are incorporated herein by reference.

### TECHNICAL FIELD

The present invention relates generally to methods of preparing flax-substituted, nutritionally-enhanced food products, by combining pre-hydrated flaxseed composition with other food ingredients. The invention further relates to stable, flax-substituted food products including such compositions.

### BACKGROUND OF THE INVENTION

Bakery products are commonly made from wheat flour containing gluten, which contributes to the typical texture, flavor and form, i.e., mouthfeel, of conventional bread, cake and pastry products. A rapidly growing number of Americans limit or avoid gluten, the protein in wheat, rye, and barley, because of an allergy or sensitivity, or because they feel its absence promotes digestive health. For some, gluten-free eating is a serious concern. Roughly one percent of Americans have celiac disease, a hereditary autoimmune response to gluten that can only be treated by avoiding all traces of the substance. Moreover, some parents and doctors suspect that consuming gluten can exacerbate autism symptoms. Unfortunately, few alternatives to gluten exist in conventional baked products.

Despite the desirability of developing bakery products that are not based on wheat flour, this development has been hindered largely by the unavailability of alternative compounds that mimic the critical role that gluten plays in the baking process. Gluten is believed to be especially important in this regard because of its unique ability to form the viscoelastic matrix of dough, which transforms it into a firm loaf of bread when baked rather than a flat cracker or a dense puck. Gluten forms strong protein strands in batters and doughs that allow gas to become trapped within, which allows for leavening upon cooking. Gluten creates that desirable springy texture in baked goods because it traps pockets of air. Typically, 5 to 7 percent of gluten is added to baked goods to increase loaf volume. Without enough gluten, a loaf of bread typically bakes up too short and dense. Enough gluten though, will yield a fluffy, or springy, loaf of bread. Gluten gives dough its elasticity and helps keep baked goods from crumbling and falling apart. It is also used to quickly thicken sauces. Gluten-free flours, however, typically have very little, if any, binding capacity and consequently, form pastes or slurries instead of springy dough with air pockets when mixed with yeast and water.

Current methods for producing gluten-free bread, for example, include mixing gluten-free flour with water, eggs, salt, sugar, yeast, milk and a small amount of binding agent, usually xanthan gum, guar gum, or pre-gelatinized starch. Unfortunately, the resulting breads are very cake-like and heavy whilst their mouthfeel and texture are generally unpleasant. As a result, many gluten intolerant individuals and those seeking gluten-limited or gluten-free diets tend to avoid eating bread products all together.

Another concern among people today is the amount of fat consumed in their daily diet. It is estimated that fat constitutes about 40 percent of the total calories in a typical diet. Fats are consumed, for example, in meats, chocolates, bakery items, oils, and fried snacks. Conventional fats generally contribute around 9 calories per gram to the total caloric content of food. The amount of fat, particularly saturated fat, in foods has been linked to potentially unhealthy effects, for example, atherosclerosis. Consumers now often seek out foods with a reduced fat content or fat-free foods to avoid what is believed to be adverse effects of such fat-containing foods.

It is known that fat plays a crucial role in the palatability of foods, however, and its reduction often detrimentally alters the sensory quality and texture of the food. Therefore, reducing or replacing fat content in food products while maintaining palatability, including good taste and texture, is a challenge faced by the industry. Attempts to resolve this problem have been made by replacing a portion of the fat in food products with lipid-, carbohydrate- and protein-based ingredients, which tend to have a lower caloric value and allow an increase in the water content compared to fat, but texture and mouthfeel are often still compromised.

Many efforts have been made to remove or lower the fat content of food products and still obtain a tasty, edible product. In response to the desire for foods with low or no fat content, various foods are now on the market that are lower in fat content or in which the fat content has been eliminated. These foods, although lower in fat, typically require consumers to compromise on the taste and texture of the food. In addition, fat-free or reduced-fat products usually require major reformulation. Replacing fat with other ingredients often requires special processing and handling, such as high shear mixing or homogenization, which adds extra steps, costs, and/or equipment to the production process.

To reduce the fat content of baked goods, it is quite popular to use a fruit puree. The fruit puree is substituted for a portion or all of the shortening, butter, or oil, which is added to the food product. One of the most frequently used fruit purees to substitute for oil, butter, or shortening is applesauce. Other fruit purees such as apricots, plums and prunes have also been used as oil, butter, and shortening substitutes in baked goods. Fruit purees have the advantage of being a naturally occurring food, which when substituted for shortening, butter, and oil have produced significantly reduced caloric values of such baked goods.

Although these fruit purees have gained a wider acceptance by the public, they have had limited success in producing baked goods having the appearance, texture and taste of their shortening, butter, or oil-containing counterparts. Many types of baked goods, such as brownies, require oil or shortening to create a moist product having a fudgy texture and glossy, cracked surface. The substitution of a fruit puree for oil or shortening in a brownie mix typically results in a dry, hard product having a sticky and a non-fudgy texture, and a non-glossy cracked surface appearance. For light colored baked goods, the addition of certain types of fruit purees such as prune purees may tarnish or discolor the light colored foods. The use of fruit purees in baked goods can also dull the natural flavors of the baked goods and/or produce off-flavors or add undue sweetness to the baked goods. Consumers tend to find these problems off-putting and detrimental to varying degrees. In addition, fruit puree substitutes have been essentially limited to substitution of oil, butter, or shortening in specially formulated baked goods, and have generally been unacceptable as an oil or shortening substitute in other food products such as salad dressings, sauces, dips, spreads, or the like.

Separately, hydrocolloids are frequently used as thickeners, texture modifiers, binders and functionality adjuncts in a wide range of food products, including liquid, baked products, meats, etc. Hydrocolloids are generally made up of proteins or carbohydrates, and typically compound with water or a water-containing material to achieve their functionality. Mostly colorless and bland, hydrocolloids tend to provide sensory enhancement in the form of texture/mouthfeel, calorie reduction, and shelf-life extension compared to shortening, oils, and butter.

The cost of using hydrocolloids, however, is often very high relative to overall production costs. Additionally, there is often negative consumer perception of hydrocolloids as being man-made and unnatural. Moreover, many hydrocolloids are high in carbohydrates, while the popularity of low carbohydrate diets, and the number of people avoiding carbohydrates for weight loss, is substantial and potentially growing.

In view of the problems described above, there remains a need for methods and products that can serve as viable substitutes for gluten, fat, hydrocolloids, or any combination thereof.

### SUMMARY OF THE INVENTION

Recently, flaxseed has become of increased importance as it contains a number of nutrients that are highly beneficial to human health. Flaxseed is a natural, beneficial, and nutritious food supplement. Flaxseed is low in carbohydrates, high in protein, and rich in dietary fiber, which offers cardiovascular benefits and helps with weight maintenance. In addition, flaxseed is a rich source of fatty acids. In baking, flaxseed may be added in its dry form to recipes as a gluten or fat substitute. Dry flaxseed, however, typically does not provide the functional requirements of the replaced gluten or fat, and therefore often negatively impacts the taste or palatability of the food product so it has not given rise to use as a gluten or fat substitute. Yet it is now desired to use flaxseeds and a method of doing so, without the adverse impact to taste and palatability, has now been discovered.

The present invention relates to a method of preparing a stable, flax-substituted food product that includes providing a plurality of flaxseeds; combining a sufficient amount of an aqueous component and the plurality of flaxseeds to form a pre-hydrated flaxseed composition; and then preparing the stable, flax-substituted food product so as to contain a reduced amount of a fat component, a hydrocolloid component, or both. The preparation includes combining an amount of the pre-hydrated flaxseed composition with a plurality of different food ingredients to substitute for the amount of fat component, hydrocolloid component, or both. The fat component and the hydrocolloid component for which the flax is substituted are substantially free of egg, and preferably do not include egg. The fat or hydrocolloid is at least substantially free of, or entirely free of, egg. The resultant food product will preferably be a reduced-calorie food, because it is believed that an equivalent amount of flax will have fewer calories than would be present in the fat or hydrocolloids replaced by the flax according to the invention.

In one embodiment, the flaxseeds include seed portions, hull portions, or a combination thereof. Preferably, the plurality of flaxseeds have an average size of about 10 microns to 2000 microns.

Typically, the combining step further includes mixing the plurality of flaxseeds and the aqueous component for about 5 seconds to about 15 minutes, or in another embodiment, from about 10 seconds to 5 minutes. In a preferred embodiment, the combining occurs within about 5° C. of room temperature.

The aqueous component is generally selected to include a pH of about 3 to 11. Another suitable aqueous component is an aqueous solution having an osmolarity of up to about 3 osmol/L.

In a preferred embodiment, the pre-hydrated flaxseed composition includes about 5 to 50 weight percent of flaxseeds in the aqueous component. Although the rate at which pre-hydrated flaxseed composition is usually combined with the different food ingredients is not important for bakery products or other solid foods, it is preferably combined at a rate of about 10 to 50 percent of the total weight of the pre-hydrated flaxseed composition per minute. In another preferred embodiment, the rate is about 25 percent of the total weight of the pre-hydrated flaxseed composition per minute into flowable food products to help ensure sufficient dispersion. Preferably, preparing the food product further includes at least substantially dispersing the pre-hydrated flax composition through the food product.

Preferably, the fat component includes a saturated fat, i.e., the flax of the present invention substitutes for saturated fat(s). The fat component that is replaced typically includes butter, an oil component, margarine, shortening, cream, or a combination thereof. Preferably, the amount of fat component, hydrocolloid component, or both is reduced by at least about 50 percent.

Suitable flax-substituted food products include a confectionary, baked good, dairy product, flowable product, savory filling, cheese, or a combination thereof. Examples of the confectionary include chocolate, fudge, or a combination thereof. Examples of the baked good include a cake, biscuit, cracker, cookie, pizza dough, bread, roll, pastry, muffin, pie crust, or a combination thereof. Examples of the flowable product include a salad dressing, dip, sauce, spread, soup, beverage, or a combination thereof. Examples of the dairy product include a yogurt, ice cream, milkshake, smoothie, or a combination thereof.

The present invention further relates to a stable, flax-substituted food product prepared according to the present method, and including about 5 weight percent to about 50 weight percent of the pre-hydrated flaxseed composition.

The invention also relates to a stable, reduced-calorie food product prepared according to the present method, and including about 0.1 weight percent to about 10 weight percent of the pre-hydrated flaxseed composition. The food product is preferably a bread or cake. In one embodiment, incorporation of the pre-hydrated flaxseed composition produces at least one of a loaf volume, loaf height, or moisture content that is at least substantially similar or higher than a food product formulated with all of the fat component and no pre-hydrated flaxseed composition, or a hardness or crumb firmness value that is at least substantially similar or lower than a food product formulated with all of the fat component and no pre-hydrated flaxseed composition. For example, the loaf volume may be increased by about 5 to 40 percent, the loaf height may be increased by about 1 to 10 percent, the moisture content may be increased by about 1 to 20 percent, or the hardness may be decreased by about 3 to 30 percent. Preferably, at least two, and more preferably, at least three of these features are present in the food product.

The bread is typically formed from a dough comprising about 40 to 65 weight percent flour, about 0.5 to 3 weight percent fat component, and about 0.5 to 4 weight percent pre-hydrated flaxseed composition. The cake is usually formed from a batter comprising about 25 to 50 weight percent flour, about 5 to 15 weight percent fat component, and about 5 to 20 weight percent pre-hydrated flaxseed composition. In a preferred embodiment, the dough includes about 57 to 63 weight percent, and more preferably about 60 weight percent whole wheat flour; about 0.7 to 1.3 weight percent, and more preferably about 1 weight percent shortening; and about 0.6 to 1.4 weight percent, and more preferably about 1 weight percent pre-hydrated flaxseed composition. Preferably, the batter comprises about 36 to 44 weight percent, and more preferably about 40 weight percent flour; about 5 to 9 weight percent, and more preferably about 7 weight percent shortening; and about 7 to 14 weight percent, and more preferably about 10 weight percent pre-hydrated flaxseed composition. The pre-hydrated flaxseed composition typically includes about 15 to 25 weight percent, preferably 20 weight percent flaxseed in an aqueous component. In a preferred embodiment, the food product includes at least about 2.5 to 7.5 weight percent, and more preferably 5 weight percent of the pre-hydrated flaxseed composition.

In addition, the present invention is directed to a bread dough that includes about 40 to 65 weight percent flour, about 0.5 to 3 weight percent fat component, about 0.5 to 4 weight percent pre-hydrated flaxseed composition, and less than about 5 weight percent gluten. Preferably, the flour is present in an amount of about 50 to 60 weight percent, the fat component is present in an amount of about 1 to 2 weight percent, the pre-hydrated flaxseed composition is present in an amount of about 1 to 3 weight percent, and the gluten is present in an amount of about 1.5 weight percent. In an exemplary embodiment, the flour comprises whole wheat flour, and the fat component comprises shortening or an oil.

The present invention also encompasses a stable, flax-substituted food product that includes an extraneous gluten component, a plurality of different food ingredients, and a plurality of flaxseeds that substitutes at least a portion of the extraneous gluten component. The ratio of the flaxseeds to the extraneous gluten component is about 1:1 to 1:8.

In one embodiment, the ratio of the flaxseeds to the extraneous gluten component is about 1:2 to 1:5. The extraneous gluten component may be, for example, wheat, rye, barley, other vital gluten, or a combination thereof. The plurality of different food ingredients include, for example, at least three of flour, yeast, sugar, salt, shortening, water, or a combination thereof. Incorporation of the flaxseeds preferably produces a loaf volume or moisture content that is at least substantially similar or higher than a food product formulated without a portion of the extraneous gluten component substituted by flaxseed, or a crumb firmness value that is at least substantially similar or lower than a food product formulated without a portion of the extraneous gluten component substituted by flaxseed. In another embodiment, the loaf volume is increased by about 5 to 25 percent, or the moisture content is increased by about 0.5 to 3 percent, compared to the food product if formulated without the flaxseed substitution. In yet another embodiment, the food product includes wheat bread.

The present invention further covers a method of preparing a stable, flax-substituted food product that includes providing a plurality of flaxseeds, and combining a sufficient amount of an aqueous component and the plurality of flaxseeds to form a pre-hydrated flaxseed composition having a substantially uniform viscosity, and then preparing the stable, flax-substituted food product so as to contain a reduced amount of an extraneous gluten component by combining a plurality of different food ingredients with an amount of the pre-hydrated flaxseed composition sufficient to substitute for the amount of the extraneous gluten component.

Preferably, at least about 50 weight percent of the extraneous gluten component is substituted. In another embodiment, the pre-hydrated flaxseed composition comprises a 5 to 35 weight percent mixture of flaxseeds in the aqueous component.

The present invention also relates to a stable, reduced-gluten food product prepared according to the present method. In one embodiment, the food product includes bread.

Another aspect of the present invention is a stable food product that includes a pre-hydrated flaxseed composition that is at least dispersed throughout a food product in an amount sufficient to provide the texture or mouthfeel of a food product that is at least substantially the same as a food product formulated with a fat component, a hydrocolloid component, or both. In a preferred embodiment, the food product is at least substantially free of a hydrocolloid component.

In one embodiment, the food product includes a flowable food product and the dispersion is at least substantially uniform. Examples of suitable flowable food products include a salad dressing, dip, yogurt, soup, sauce, spread, beverage, or a combination thereof. In an exemplary embodiment, the food product includes at least about 5 weight percent of the pre-hydrated flaxseed composition along with the other food components forming the remainder.

Yet another aspect of the present invention is a flax product that includes a plurality of flaxseeds; and instructions to combine the flaxseeds and an aqueous component to form a pre-hydrated flaxseed composition before addition to different food ingredients; and instructions to then use less of, or replace a portion of the fat component, hydrocolloid content, or both, to prepare a food product by combining the pre-hydrated flaxseed composition with the different food ingredients. The fat component and the hydrocolloid component do not include egg.

Preferably, the flaxseeds include seed portions, hull portions, or a combination thereof. In one embodiment, the plurality of flaxseeds are, or the instructions provide that, the plurality of flaxseeds should be sized and dimensioned on average to be about 10 microns to about 800 microns.

In another embodiment, the instructions provide that the food product is a bakery product or a flowable product. Typically, the instructions provide that the bakery product is a cake, biscuit, cracker, cookie, pizza dough, bread, roll, pastry, muffin, or pie crust, or that the flowable product is a salad dressing, dip, spread, soup, yogurt, sauce, or beverage.

The present invention further relates to a method of minimizing fat, hydrocolloid content, or both in a food product, that includes providing a plurality of flaxseeds and providing instructions to a food manufacturer according to the present invention.

Lastly, the present invention relates to a method of selling flaxseeds. The method includes informing a food manufacturer of the ability to substitute pre-hydrated flaxseed compositions for a portion of the fat component, hydrocolloid component or both when preparing a food product; and providing the flaxseeds with the instructions of the present invention. The instructions are provided through the informing of the food manufacturer, with the providing of the flaxseeds, or both.

### BRIEF DESCRIPTION OF THE DRAWINGS

The present disclosure can be better understood from the following detailed description when read with the accompanying figures.

FIG. 1 illustrates the impact of replacing oil with flaxseed on loaf volume according to an embodiment of the present invention;

FIG. 2 illustrates the human sensory and instrumental hardness of baked whole wheat breads at day 0 according to an embodiment of the present invention;

FIG. 3 illustrates bread hardness during storage for six days according to an embodiment of the present invention; and

FIG. 4 illustrates the effect of temperature on flax solution viscosity according to an embodiment of the present invention.

### DETAILED DESCRIPTION OF PREFERRED EMBODIMENTS

The present invention is directed to flax-substituted food products that no longer need a portion of the gluten, fat, hydrocolloid, or all three, that would have been conventionally included to provide a stable, palatable food product. Flaxseeds that are in a hydrated form are used to replace, or in place of, a portion of the gluten component, fat component, hydrocolloid component, or all three, in food products. The present invention advantageously uses flaxseed in a hydrated form to reduce fat, and specifically saturated fat, in numerous food applications, including bakery and biscuit products. The present invention also allows for the use of flaxseeds in a hydrated form to replace a portion of gluten component in a food product, particularly bread and cake products. Further, the present invention permits a portion of hydrocolloid component in a food product, specifically flowable food products, to be replaced by a flaxseed composition according to the invention, along with the resultant flowable food. Without being bound by theory, it is believed that the pre-hydrated flaxseed composition of the invention acts as a rheological modifier and texture modifier in a wide variety of food products, particularly bakery products and flowable foods. When the pre-hydrated flaxseed composition is added to a food as a gluten, hydrocolloid, or fat substitute, or all three, the substitution of pre-hydrated flax for a portion of gluten, fat, hydrocolloid, or all three provides a food with substantially similar palatability and taste to the consumer, coupled with fewer calories, a desirable texture, excellent eating quality, increased nutritional value, and long shelf-life/stability.

Flaxseeds are typically flat, oval and pointed at one end. They contain a seed coating and an embryo comprising two large, flattened cotyledons, a short hypocotyl and a radical. The seed coating (or hull) of flaxseeds is formed from the ovule and has five hull layers, two of which are considered important. These two hull layers are the epidermal layer, commonly called the mucilage layer, and the testa that consists of pigmented cells, which primarily determine the seed's coloring.

One of the major benefits of processing flaxseeds into a nutritional supplement for humans is the fact that they naturally contain lignans typically in an amount of 0.7 percent to 1.5 percent by weight. High lignan-content processed flaxseeds are believed to hold special pharmaceutical benefits inasmuch as they exhibit broad biological activities, including antitumor, antioxidant, antiviral, estrogenic, and anti-estrogenic activities. As described in several pending patents and patent applications, which are incorporated below, such flaxseed products are commercially available from Pizzey's Milling of Manitoba, Canada. The lignans are generally cinnamic acid dimers containing a dibenzylbutane skeleton. The primary lignan found in flaxseed is secoisolariciresinol diglycoside (SDG). Other benefits include the fact that it is a rich source of essential fatty acids.

Flaxseed is non-allergenic, gluten-free, and has a low glycemic index. Moreover, consumer perception of flaxseed is positive because consumers perceive flaxseed as healthy and wholesome. Thus, in preferred embodiments, pre-hydrated flaxseed compositions of the invention can be used in non-allergenic food products, low or gluten-free food products, and low glycemic food products. Such compositions can also be substituted for gluten because they can advantageously provide at least substantially the same properties in terms of volume in a bakery product. As used herein, “food products” encompass both raw and cooked products, unless it is noted that the food product is baked or partially cooked. For example, in the case of bread, food products can include both the baked product and the dough. The pre-hydrated flaxseed composition is preferably used in the same manner, time, and place as the conventional gluten added to bakery products and other food products. The flaxseed can be used to substitute for a portion of an extraneous gluten component in, for example, appetizers, main courses, sides, and desserts, and particularly in pizza crusts, muffins, bread, cakes, and cookies. As used herein, “extraneous gluten” or “extraneous gluten component” means added gluten that is not already present in the other ingredients in the bakery or food products. For example, in whole wheat bread, the extraneous gluten does not include the gluten naturally present in the whole wheat flour. Preferably, flaxseed is used in place of a portion of extraneous gluten in rising dough products like bread, muffins, and cakes. As used herein, “bread” preferably means a product that rises or has risen during preparation, and excludes tortilla shells and other flat products. In gluten-free applications, the flaxseed may be used to substitute intrinsic gluten (i.e., vital wheat gluten) from various grain flour sources. Preferably, however, the embodiments herein relating to substitution of flaxseed for a portion of wheat gluten are typically referring to the extraneous wheat gluten added to bakery products, for example, to increase volume and reduce hardness.

The present invention advantageously allows for the replacement of about 25 to 90 percent, preferably about 40 to 75 percent of the extraneous gluten component, which is typically added to conventional bakery food products to increase volume and help provide a suitable texture. In a most preferred embodiment, about 45 or more, or even about 50 percent or more of an extraneous gluten component is replaced, which results in a product with better or increased loaf volume, and the same or better crumb structure. Substitution of the extraneous gluten component not only improves the characteristics of the baked goods, but also tends to reduce product costs as flaxseed is often less expensive than gluten. Advantageously, the resultant products have reduced gluten content, which is helpful to consumers having sensitivity to the amount of gluten present in their food. In one embodiment, the cost of a loaf of bread was reduced by about 4 percent, with a corresponding about 1.4 percent increase in loaf volume. In another embodiment, the cost of the loaf according to the invention was reduced by about 5 percent compared to a conventional loaf with a typical amount of extraneous gluten added. Another benefit of the use of flaxseed is improved moisture retention in baked loaves, resulting in softer bread that stays soft over at least a typical week-long shelf-life.

The “flaxseeds” used in the present invention may refer to whole seeds, seed portions, hull portions, or any combination thereof. The source of flaxseed may be combined with one or more fish oils as described in U.S. Publication No. 2008/0069942, the entire contents of which are incorporated herein by express reference thereto. The flaxseeds are any suitable type of flaxseeds, but are preferably substantially free of seeds and preferably are just hull portions. More preferably, the flaxseeds are prepared according to one or more of U.S. Publication No. 2006/0210691, U.S. Pat. No. 6,368,650, and U.S. Pat. No. 7,048,960, each of which is entirely incorporated herein by express reference thereto. The particle size and type of flaxseed used depends in part on the application, e.g., whether it will be substituted as a hydrocolloid, as a fat component, as a gluten component, or all three, and whether or not it is also intended to function as a nutritional supplement, for increasing or preventing the decrease in water absorption, for dough impact, and/or for visual impact in providing a food product that has at least substantially the same appearance as a bakery or flowable product that does not contain the pre-hydrated flaxseed compositions of the invention.

To facilitate hydration according to the invention, the flaxseeds (or seeds or hulls thereof) are generally milled, or ground, to a smaller size before combination with an aqueous component. A wide range of sizes of flaxseeds are suitable for use in the present invention. The flaxseeds can typically have an average size of about 10 microns to 2000 microns, preferably about 200 microns to 1200 microns, and more preferably about 350 microns to 900 microns. In an exemplary embodiment, the flaxseeds are the hull portions substantially free of the seeds and have an average size of about 550 microns to 850 microns. In various embodiments, smaller flax particles within these ranges can improve functionality of the pre-hydrated flaxseed composition as a hydrocolloid component substitute.

The aqueous component contains water in an amount sufficient to hydrate the flaxseeds. In a preferred embodiment, the aqueous component is water with no more than trace amounts of impurities, such as water treatment and softening chemicals. Hydration of the flaxseeds preferably uses the minimum amount of the aqueous component required to fully functionalize the flax, while maintaining pumpability, fluidity, and processability. The flaxseeds having the appropriate particle size are combined with an aqueous component and mixed for a sufficient time to form pre-hydrated flaxseeds according to the invention. It has been found that even without hydration, the flaxseeds can suitably replace a portion of a hydrocolloid component, particularly in liquid food products such as salad dressings, soups, dips, spreads, yogurts, and the like. Suitable salad dressings can be flavored and include, but are not limited to, classic ranch and honey mustard dressings.

In varying embodiments, the pre-hydrated flaxseed composition includes about 5 to 50 weight percent of flaxseeds in the aqueous component, preferably about 10 to 40 weight percent, and more preferably about 15 to 35 weight percent. The remainder of the pre-hydrated flaxseed composition is generally the aqueous component, i.e., the aqueous component makes up about 50 to 95 weight percent of the pre-hydrated flaxseed composition. In an exemplary embodiment, the pre-hydrated flaxseed composition is a 20 weight percent flaxseed in 80 weight percent aqueous component, e.g., water. In another preferred embodiment, the flaxseed composition or mixture is a solution, or the functional portion adapted to replace a portion of extraneous gluten is in solution. Therefore, in one embodiment, a solution of flaxseed can be separated through conventional separation techniques and used as the flaxseed composition.

In another embodiment, the aqueous component is selected to include a pH of about 3 to 11, preferably about 4 to 9, and more preferably about 5 to 7. The ability to hydrate the flaxseeds with a wide range of pHs can advantageously allow the pre-hydrated flaxseed composition to be used in various food products such as salad dressings, which can vary from more acidic to neutral.

In yet another embodiment, the aqueous component is selected to have an osmolarity of up to about 3 osmol/L. Aqueous components ranging from distilled water to a 3% salt solution have been found to be suitable for use in hydration of flaxseeds according to the invention.

Combining the flaxseeds with the aqueous component includes mixing the seeds with the component for typically about 5 seconds to about 5 minutes, although longer mixing times are not detrimental to the composition's ability to form a sufficiently viscous pre-hydrated flaxseed composition for combination with a food product. Preferably, the mixing is done within about 5 degrees Celsius of room temperature, without requiring the addition of heat. Alternatively, the mixing may be done at higher temperatures, including temperatures up to about 50° C. if desired to combine the components in the early stage of baking a food product. Unlike starches and gums that normally increase in viscosity with increases in temperature, the flaxseeds maintain substantially the same viscosity at 5° C. and 25° C., with slightly lower viscosities at 35° C. This advantageously permits or facilitates mixing, pouring, and other conventional operations to prepare suitable and desirable food products. Once the pre-hydrated flaxseed composition is formed, it may be chilled, stored for up to about 48 hours, and later added to other food ingredients.

To prepare a stable, flax-substituted food product, an amount of the pre-hydrated flaxseed composition is combined with different food ingredients. The food ingredients can include a fat component, a hydrocolloid component, a gluten component, or all three, that are replaced, or substituted, by the amount of pre-hydrated flaxseed composition to form the stable food product. The fat component and hydrocolloid component do not include egg. The flaxseed compositions may also be used to reduce the total flour/starch content in food to produce a low carbohydrate food product, which can also help provide a low glycemic index food product.

Combination of the pre-hydrated flaxseed composition and the different food ingredients can be achieved at any suitable rate from low to high, particularly if the composition is added to increase viscosity. This is typically only necessary for flowable food products, and in this situation the combination can be in increments of about 10 to 50 percent, preferably about 15 to 35 percent, and in one exemplary embodiment about 25 percent, of the total weight of the pre-hydrated flaxseed composition over the course of a one minute period.

Rate of addition can be dependent on a variety of factors, including the type of mixer, temperature, viscosity of material into which the pre-hydrated flax is being combined, and the chemistry of the material (e.g., remaining fat content). Experiments have indicated that in some materials, the entire quantity of pre-hydrated flax can be added all at once, while in others, metering may provide improved performance and minimize impact to the properties of the food ingredient(s) to which the pre-hydrated flax is being combined. In liquid food products with emulsions, the rate of addition will be primarily dependent on mixing shear, overall product composition, and stability. It is common to add oil-containing ingredients slowly to these aqueous-based systems. Once the different food ingredients are combined, the pre-hydrated flax composition should be substantially dispersed through the combined different food ingredients to ensure uniformity in taste and texture of the resultant food product.

Because of the flaxseeds' ability to retain water, the end product tends to have more moisture. Increased water binding of the flaxseeds also inhibits or prevents moisture migration away from the food product compared to the gluten component, fat component, hydrocolloid component, or all three, for which the pre-hydrated flax composition has been substituted. This can result in decreased staling and improved shelf-life of the food products prepared according to the invention. The quality of the food products was not compromised, and the microbial count was no higher than normal, when prepared with the pre-hydrated flaxseed compositions of the invention. More water, however, may need to be added during preparation. For food products that are baked or dried to a specific moisture target, increased time or temperature of combining or mixing, of setting before combination with other food components, or of baking the food products, may also be required.

The food products of the invention have improved microwavable properties. In particular, the combination of the pre-hydrated flaxseed composition tends to reduce or inhibit hardening of dough products that typically occurs during microwaving. The microwaved dough is thus softer and has a more consistent texture throughout when prepared according to the invention to include a pre-hydrated flaxseed composition.

The present invention advantageously can permit at least about 50 percent of the fat component, hydrocolloid component, gluten component, or all three, to be replaced, while also providing excellent texture, stability, and mouthfeel to the resulting food product. In preferred embodiments, no more than about 90 weight percent of the fat component, hydrocolloid component, gluten component, or all three, are replaced.

The food product typically includes from about 5 weight percent to about 50 weight percent of the pre-hydrated flaxseed composition, preferably about 15 to 40 weight percent, and more preferably about 20 to 35 weight percent. In one embodiment, the ratio of the pre-hydrated flaxseed composition to the fat, hydrocolloid, gluten component, or all three, in the food product ranges from about 1:10 to about 10:1.

Hydrocolloid components have been used in the food industry as a thickening agent and stabilizing agent in a variety of food products. For example, hydrocolloids are used in salad dressings and pectin jellies, often as a thickening agent. By “hydrocolloid component” is meant those substances that influence the physical properties of water. In particular, hydrocolloid components are typically substances that swell and produce a viscous dispersion, suspension, or solution when exposed to water, and/or act as binders. A hydrocolloid component can include one or more functional proteins such as, gelatin, myosin, sarcoplasmic proteins, albumens, and globulins; gums, such as, galactomannans, glucomannans, and microbials (e.g., xanthan gum and guar gum); gels, such as, seaweed extracts (e.g., carrageenan), pectinaceous materials, and konjacs; and other macromolecular entities such as, cellulosics, glucans, starches, and clays.

The amount of hydrocolloid component replaced in a given type of food product is dependent on the type of hydrocolloid used, its rheological properties, and those of the overall system. More specifically, it depends on whether rheology is dependent on fat, hydrocolloid, or some other ingredient or combination of ingredients. In a most preferred embodiment, the food product is at least substantially free, preferably entirely free, of a hydrocolloid component. In exemplary applications, levels of about 50 to 100 weight percent of the hydrocolloid component are substituted with the pre-hydrated flax composition according to the invention. For example, all of the hydrocolloid components were successfully replaced by the pre-hydrated flax composition in a salad dressing application without sacrificing taste or mouthfeel, i.e., without losing the expected taste, creaminess, or mouthfeel that existed with a conventional hydrocolloid component. Preferred levels of hydrocolloid replaced can be from about 5 to 100 weight percent of the hydrocolloid component, and in alternative embodiments preferably about 20 to 100 weight percent, about 30 to 100 weight percent, about 40 to 100 weight percent, about 60 to 95 weight percent, or about 65 to 90 weight percent of the hydrocolloid component.

By varying the amount of pre-hydrated flaxseed composition present in the food product, the texture and mouthfeel of the product can be varied over a wide range to replace varying levels of fat component, hydrocolloid component, or both. Increasing the amount of the pre-hydrated flaxseed composition present in the food product can increase the viscosity of the product when consumed and thus, can substitute for the thickening function of a conventional hydrocolloid component and varies the mouthfeel of the product. For example, varying the amount of the flaxseed composition can lead to a product that has a slightly thickened texture, a chewy texture or even a slimy texture. When used to modify texture and mouthfeel, the pre-hydrated flaxseed composition is typically present in the food product in an amount from about 0.1 to 20 percent by weight. Preferably, the flaxseed composition is at least about 0.5 weight percent to 17.5 weight percent of the food product, or about 5 weight percent to 15 weight percent, and more preferably from about 1 to 10 weight percent of the food product. The present invention permits more expensive hydrocolloid components to be replaced with a natural, highly-functional, healthier, hydrocolloid-rich ingredient, while optionally but preferably reducing costs through the use of flaxseed, which is typically less expensive than conventional hydrocolloids. For example, in ranch dressing applications, when xanthan gum and modified starch were replaced with flaxseeds, a savings of about 9 percent was achieved while attaining a healthier product with suitable physical characteristics. Similarly, when modified starch was replaced with flaxseeds in one honey mustard dressing test, a savings of about 6 percent was similarly achieved.

The amount of the fat component replaced is generally high, and can be at a level of at least about 50 weight percent, although substitution of lower amounts of fat component with the pre-hydrated flaxseed composition, e.g., about 5 to 50 weight percent, are also suitable. The pre-hydrated flaxseed composition can be used to reduce saturated fats or total fat that would otherwise be required or used in various food products, and preferably baked products and flowable products. The pre-hydrated flaxseed composition should be used in the same manner, time, and place as the fat. There is variation in the amount of fat component replaced since the amount depends on whether rheology of a given food product is dependent on fat, hydrocolloids, or other ingredients. The present invention provides stable, flax-stabilized food products with at least substantially the same organoleptic properties as those of full fat products, and maintains a moist, flavorful food product. Preferably, these are also reduced-calorie food products, which can be achieved by substituting lower-calorie flaxseed compositions for amounts of a fat component. The addition of the flaxseed composition can provide a smooth and creamy mouthfeel, as well as a texture and lubricity, that approach the texture and mouthfeel of edible fat containing food products for which the flaxseed composition described herein has not been substituted in as a portion of the fat content. By “portion” it is meant herein that some or all, but preferably some, with respect to the replaced fat content.

The pre-hydrated flaxseed composition may be used to replace a gluten component, fat component, a hydrocolloid component, or all three, in several types of food products. In a preferred embodiment, the pre-hydrated flaxseed composition is used to replace shortening or oil in bread. The replacement by flaxseed surprisingly reduces the fat content of the bread, increases bread volume, and reduces the cost of the dough. This typically is also a healthier option to have less fat content and more natural seed content. When used in cake, for example, the pre-hydrated flaxseed composition increases volume, moisture, and “loaf” height. The compositions of the invention can preferably used to replace various types of fat, and specifically saturated fat, used in baking.

Eating foods that contain saturated fats typically raises the level of cholesterol in blood. High levels of blood cholesterol tend to increase the risk of heart disease and stroke. Saturated fats occur naturally in many foods. The majority come from animal sources, including meat and dairy products. Examples are fatty beef, lamb, pork, poultry with skin, beef fat (tallow), lard and cream, butter, cheese and other dairy products made from whole or reduced-fat milk. In addition, many baked goods and fried foods can contain high levels of saturated fats. A suitable fat component that may be replaced (i.e., substituted) according to the invention with flaxseed compositions or components can include without limitation butter, an oil component, margarine, shortening, cream, or any combination thereof.

Saturated fat provides a functionality not easily replicated by oils, which is particularly important in baked products. Oils do not typically provide the same organoleptic properties that saturated fats provide. This is one of the reasons that reduction or elimination of trans-fatty-acids in food has been so difficult, and often leads to increased saturated fat levels in reduced or non-trans-fatty acid containing food products.

The present invention permits the replacement of a portion of unhealthy saturated fats with a beneficial flaxseed composition, while also preserving the consumer-detectable taste and quality when consuming the food product. For example, partially hydrogenated soybean oil shortening or butter was successfully substituted with soybean oil and the pre-hydrated flaxseed composition in a cookie product. The shortening and soybean oil were commercially available from Archer-Daniels-Midland Company. Both vegetable shortening and butter are typically high in saturated fats, while vegetable oils tend to be high in polyunsaturated fats, with no trans-fat, and low saturated fats.

To maintain product quality and process capabilities of reduced-fat food items is well-known to be both difficult and expensive in most cases. The present invention, however, has the ability to reduce the total and saturated fat content of food products, and to instead introduce a nutritionally valuable ingredient of flaxseed.

Representative edible materials that can be prepared by substituting the pre-hydrated flaxseed composition of the present invention in full or partial replacement of the gluten component, fat component, hydrocolloid component, or all three, are: comminuted meat items, e.g., meatloaf, ground sirloin, and hamburger; dairy products, e.g., ice cream, ices, milkshakes, smoothies, yogurts, and the like; puddings and pie fillings; butter or margarine substitutes or blends; mayonnaise; flowable food products, e.g., salad dressings, dips, sauces, soups, spreads, beverages, and the like; whipped toppings; frostings and fillings; confectionaries, e.g., chocolate, fudge, and the like; and baked products, e.g., cakes, biscuits, crackers, cookies, pizza doughs, breads, rolls, pastries, muffins, pie crusts, and the like. Preferably, the baked products are those with low water content, e.g., less than about 5 weight percent water, more preferably less than about 1 weight percent water. It should be understood that the terms “e.g.” and “for example” wherever they appear herein are intended to be without any limitation.

Testing of various levels of flaxseed in cake products demonstrated suitable or even significantly improved cake volume, moistness, shelf-life, and overall flavor. Cake samples made with the flax that were stored for 3 and 7 days after baking actually had better organoleptic and/or storage properties than those made without flax. Similar results were achieved with replacement of about 30 percent of the fat with the pre-hydrated flaxseed composition in cake. In one embodiment, the present invention provides a food product that is at least substantially free of, and preferably entirely free of, gluten-containing products. The development of gluten affects the texture of baked goods. In bakery products, flax fiber can interrupt gluten development. Addition of the pre-hydrated flaxseed composition of the invention, however, softens any existing gluten fibers and minimizes the impact to gluten development. One can further adjust baking times and temperatures to form a product with a desirable taste and texture.

Flowable products are those food products that can be gel-like when chilled, but behave more like liquids at room temperature. The viscosity of the flowable food product when chilled is about 500 to 40,000 cP, preferably about 1,000 to 10,000 cP, and more preferably is about 2,000 to 8,000 cP. At room temperature, its viscosity is preferably about 1,000 to 3,000 cP.

To obtain optimum results, in one preferred embodiment, the pre-hydrated flaxseed composition is preferably dispersed throughout the flowable food product, more preferably in at least a substantially uniform manner, and more preferably in a uniform manner. As used herein, the term “substantially uniform” means the uniformity necessary to result in a product having the desired properties, preferably with less than about an 80 percent variation, more preferably less than about a 50 percent variation, even more preferably less than about a 25 percent variation, and most preferably less than about a 10 percent variation in the amount of pre-hydrated flaxseed composition in any given volume of the final food product (e.g., a cheese spread or a baked cracker).

The flowable food products, especially sauces, remain surprisingly stable, even after freezing and defrosting. Importantly, these food products do not exhibit syneresis, or the tendency to gel when liquid is separated from the solids or more viscous materials. Syneresis is common in many conventional sauces that are stored on a shelf as opposed to made and served fresh.

The present invention also includes flax products that may be sold in stores or directly to food manufacturers for baking and cooking, particularly those associated with instructions as to how a fat component, hydrocolloid component, or both could be replaced in preparing a food product with the pre-hydrated flaxseed compositions of the invention. The flax product thus preferably includes flaxseeds and instructions on how to use the flaxseeds in food products, including bakery and flowable food products. Any suitable container may be used for the flaxseeds, including without limitation packets, resealable plastic bags, plastic tubs, cans, glass or plastic jars, and the like.

The instructions may be printed directly onto the container, or included as a separate insert. The instructions can also be associated with the product in a newspaper advertisement, a flyer, a brochure, or an electronic bulletin board, such as on a website. The instructions are preferably simple, and direct the food manufacturer or consumer to combine the flaxseeds and an aqueous component according to the invention described herein before addition to different food ingredients, and to then minimize or replace a portion of the fat or hydrocolloid content, or both, in a conventional food product with the pre-hydrated flaxseed composition. The fat or hydrocolloid that is replaced preferably does not include egg.

The flax product can be used to advantageously minimize gluten content, fat content, hydrocolloid content, or all three, in a food product. In addition to instructions on substituting the flaxseeds for a portion of the gluten, fat, hydrocolloid or all three, the instructions may optionally also include low-fat, healthy recipes, such as for bakery products, flowable products, or both. In one preferred embodiment, such instructions are for one or more bakery products that can be made by an individual at home.

As used herein, the term “substantially free” or “essentially free” means that a composition contains less than about 10 weight percent, preferably less than about 5 weight percent, and more preferably less than about 1 weight percent of a compound, component, or value referred to. In a preferred embodiment, these terms refer to less than about 0.5 weight percent, more preferably less than about 0.1 weight percent of the compound, component, or value.

The term “substantially similar” means that the characteristic is at least about 75 percent similar, preferably at least about 80 percent similar, more preferably at least about 90 percent similar, and most preferably at least about 95 percent similar to the characteristic for a product where a portion of the fat, hydrocolloid, or gluten component has not been replaced with a pre-hydrated flaxseed composition. By “substantially similar viscosity” means a variation in viscosity of less than about 50 percent, preferably less than about 40 percent, more preferably less than about 30 percent, and most preferably less than about 20 percent. In a preferred embodiment, there is less than about a 10 percent variation in viscosity.

The term “about,” as used herein, should generally be understood to refer to both numbers in a range of numerals. For example, “about 1 to 2” should be understood as “about 1 to about 2.” Moreover, all numerical ranges herein should be understood to include each whole integer within the range.

Each of the patent applications, patents, publications, and other published documents mentioned or referred to in the Detailed Description is incorporated herein in its entirety by express reference thereto, to the same extent as if each individual patent application, patent, publication, and other published document was specifically and individually indicated to be incorporated by reference.

### EXAMPLES

The invention is further defined by reference to the following examples, describing in detail the study used to investigate the compositions and methods of the present invention. These examples are for illustrative purposes only, and are not to be construed as limiting the appended claims. All percentages provided below are based on weight, unless otherwise noted.

### Example 1

### Shortening Reduction in Bread with Blend Flour of the Invention

Five compositions were prepared according to Table 1 below. The control composition was prepared using 100 percent of the shortening typically used in bread dough. The amount of the shortening was decreased in the other compositions, and flaxseed used to substitute that portion of the shortening. The flaxseed was either added as dry flax or as a 20 percent by weight flax mixture with the remainder being an aqueous component.

TABLE 1
Test Bread Compositions

| | 100% | | 75% | 50% | 50% |
|---|---|---|---|---|---|
| | shortening | 50% | shortening | shortening | shortening |
| | (control) | shortening | 25% flax | 50% flax | 50% dry |
| | No flax | No flax | mixture | mixture | flax |
| Whole wheat | 100.00 | 100.75 | 100.00 | 100.00 | 100.00 |
| flour | | | | | |
| Shortening | 3.00 | 1.50 | 2.25 | 1.50 | 1.50 |
| Flax | 0.00 | 0.00 | 0.15 | 0.3 | 0.30 |
| Water for | 0.00 | 0.00 | 0.6 | 1.2 | 0.00 |
| flax | | | | | |
| Dry yeast | 1.00 | 1.00 | 1.00 | 1.00 | 1.00 |
| Sugar | 6.00 | 6.00 | 6.00 | 6.00 | 6.00 |
| Salt | 1.50 | 1.50 | 1.50 | 1.50 | 1.50 |
| Water | 65.00 | 65.75 | 64.94 | 63.80 | 65.00 |
| Malted | 0.20 | 0.20 | 0.20 | 0.20 | 0.20 |
| barley | | | | | |

The bread dough was kneaded and baked. Bread volume was measured for each of the five compositions in Table 1, and the results are shown below.

TABLE 2
Volume Increase

| | | % volume |
|---|---|---|
| | | increase |
| 100% shortening no flax (control) | 471.21 | |
| 50% shortening no flax | 476.60 | 1.14% |
| 75% shortening 25% flax mixture | 477.51 | 1.34% |
| 50% shortening 50% flax mixture | 488.55 | 3.68% |
| 50% shortening 50% dry flax | 479.60 | 1.78% |

Reducing the amount of shortening lowered the cost of the final product. As can be seen above, all of the compositions with flaxseed showed an increase in volume, with lower costs. In the best sample, bread volume was increased by as much as about 3.5 percent by substituting about half of the shortening with a pre-hydrated flax component that is 20 percent by weight flax (with the remainder of the flax component being an aqueous component, e.g., water). Another benefit of the addition of the flaxseed was bread that was softer than the control.

### Example 2

### Shortening Reduction in Yellow Cake of the Invention

Five cake compositions were prepared according to Table 3 below. A portion of the shortening was replaced with dry or pre-hydrated flax.

TABLE 3
Test Cake Compositions

| | | Replace 15% | Replace 15% | Replace 30% | Replace 30% |
|---|---|---|---|---|---|
| | | shortening | shortening | shortening | shortening |
| | | with dry | with hydrated | with dry | with hydrated |
| | | flax (2%) | flax (2%) | flax (2%) | flax (2%) |
| Cake Flour | 39.10% | 38.64% | 38.64% | 40.10% | 40.10% |
| Baker's Special Sugar | 36.20% | 36.20% | 36.20% | 36.20% | 36.20% |
| Shortening | 9.70% | 8.25% | 8.25% | 6.79% | 6.79% |
| Powdered Sugar | 4.40% | 4.40% | 4.40% | 4.40% | 4.40% |
| NFDM | 2.81% | 2.81% | 2.81% | 2.81% | 2.81% |
| Whole Egg | 3.25% | 3.25% | 3.25% | 3.25% | 3.25% |
| Com Syrup Solids | 1.87% | 1.87% | 1.87% | 1.87% | 1.87% |
| Salt | 1.00% | 1.00% | 1.00% | 1.00% | 1.00% |
| Baking Powder | 0.86% | 0.86% | 0.86% | 0.86% | 0.86% |
| Sodium Bicarbonate | 0.72% | 0.72% | 0.72% | 0.72% | 0.72% |
| Cellulose Gum | 0.09% | — | — | — | — |
| Flax, dry | — | 2.00% | — | 2.00% | — |
| Flax (dry weight used as | — | — | 2.00% | — | 2.00% |
| 20% mixture (Added at | | | | | |
| time of water addition)) | | | | | |

The cake batter was prepared, and the different cakes baked. Below are the results when each composition was tested for volume, hardness, moisture, loaf height, color (L value), and color (b value).

TABLE 4
Volume, Hardness, Moisture, Loaf Height, and Color (L and b values) Data

| | | | | Loaf | Color | Color |
|---|---|---|---|---|---|---|
| Samples | Volume | Hardness | Moisture | height | (Lvalue) | (b value) |
| Control | 211.82 | 939.49 | 27.54 | 5.57 | 80.63 | 27.61 |
| Replace 15% shortening | 232.82 | 850.96 | 27.43 | 5.78 | 77.23 | 28.43 |
| with dry flax (2%) | | | | | | |
| Replace 15% shortening | 232.12 | 852.21 | 28.33 | 5.77 | 76.09 | 29.56 |
| with hydrated flax (2%) | | | | | | |
| Replace 30% shortening | 235.16 | 875.58 | 27.93 | 5.82 | 77.72 | 28.20 |
| with dry flax (2%) | | | | | | |
| Replace 30% shortening | 241.11 | 949.57 | 28.13 | 5.92 | 77.54 | 29.27 |
| with hydrated flax (2%) | | | | | | |

Both dry and pre-hydrated flaxseed resulted in greater volume of the cake. Hardness decreased with three of the flax compositions, and increased when 30 percent of the shortening was replaced with hydrated flax. The softest cakes had 15 percent of the shortening replaced with dry or pre-hydrated flax. Notably, loaf height was increased in all of the flax compositions where a portion of the shortening was replaced. Loaf height was at its maximum when 30 percent of the shortening was replaced with hydrated flax. Color values were not significantly affected by the replacement of shortening by flax. As was expected, L values were a little bit lower with the addition of flax. The flax made the cake brown at a faster rate. The b value did not fluctuate significantly, which demonstrated that the yellow color of the cake was not adversely affected. Overall, the replacement of a substantial portion of shortening with a hydrated flax provided a cake product superior in terms of health, fat content, and volume, without substantial degradation of the hardness or color.

### Example 3

### Oil Reduction According to the Invention

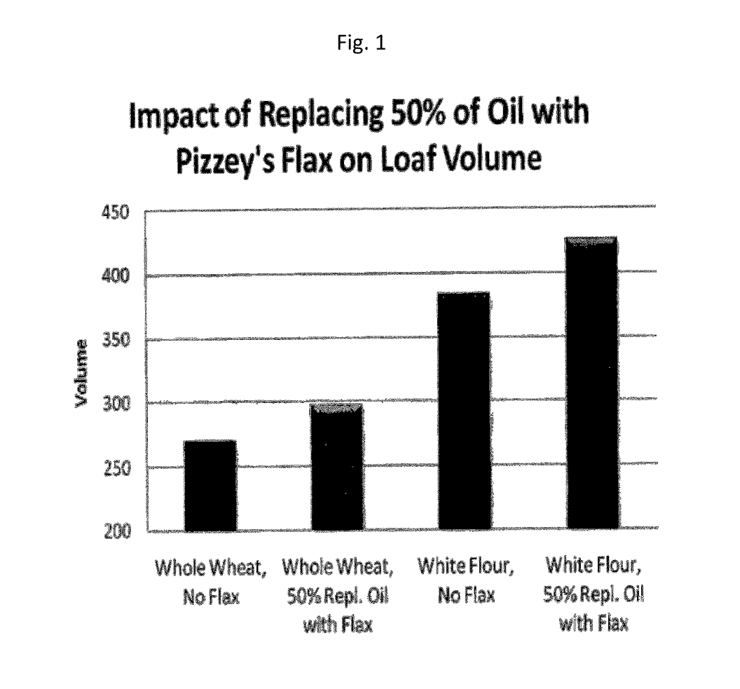

Flaxseed was used to substitute half the oil in a whole-wheat and a white flour bakery product application. Loaf volume was increased significantly in both applications where the oil was replaced with pre-hydrated flaxseed according to the invention. FIG. 1 illustrates the impact of replacing oil with flaxseed on loaf volume according to this embodiment.

### Example 4

### Gluten Reduction In Whole Wheat Bread of the Invention

A. Six compositions of whole wheat bread were prepared. The control contained 5 percent gluten, while the other compositions had varying but lesser amounts of gluten. In these compositions, a portion of the extraneous gluten was substituted with dry or pre-hydrated flax.

TABLE 5
Test Wheat Bread Compositions

| | | | 2.5% gluten | 2.5% gluten | 2.5% gluten | |
|---|---|---|---|---|---|---|
| | 5% gluten | 2.5% gluten | 2.5% flax | 5.0% flax | 7.5% flax | 2.5% gluten |
| | no flax | no flax | mixture | mixture | mixture | [symbol] .5% dry flax |
| whole wheat Flour | 95.00 | 97.50 | 97.00 | 96.50 | 96.00 | 96.00 |
| flax | 0.00 | 0.00 | 0.50 | 1.00 | 1.50 | 1.50 |
| water for flax | 0.00 | 0.00 | 2.00 | 4.00 | 6.00 | 0.00 |
| gluten | 5.00 | 2.50 | 2.50 | 2.50 | 2.50 | 2.50 |
| Dry yeast | 1.00 | 1.00 | 1.00 | 1.00 | 1.00 | 1.00 |
| sugar | 6.00 | 6.00 | 6.00 | 6.00 | 6.00 | 6.00 |
| salt | 1.50 | 1.50 | 1.50 | 1.50 | 1.50 | 1.50 |
| shortening | 3.00 | 3.00 | 3.00 | 3.00 | 3.00 | 3.00 |
| water | 70.00 | 70.00 | 68.00 | 66.00 | 64.00 | 70.00 |
| malted barley | 0.20 | 0.20 | 0.20 | 0.20 | 0.20 | 0.20 |

[symbol]

indicates data missing or illegible when filed

As demonstrated in Table 6 below, the substitution of the gluten with flaxseeds replacing a portion of the typical gluten amount resulted in an increase in volume.

TABLE 6
Volume Increase

| | | % volume |
|---|---|---|
| | Volume | increase |
| 5% gluten no flax (control) | 422.14 | — |
| 2.5% gluten no flax | 429.09 | 1.65% |
| 2.5% gluten 2.5% flax mixture | 457.86 | 8.46% |
| 2.5% gluten 5% flax mixture | 498.40 | 18.07% |
| 2.5% gluten 7.5% flax mixture | 481.46 | 14.05% |
| 2.5% gluten 7.5% dry flax | 460.51 | 9.09% |

Costs of the entire loaf were reduced by decreasing the amount of added gluten in the bread and replacing it with dry flax or flax mixture. The 2.5 percent gluten and 5 percent flax mixture performed the best out of all the test compositions, with a notable reduction in cost and the largest volume increase. This composition surprisingly and unexpectedly increased loaf volume by almost 20 percent while achieving a reduction in cost of these added texturing components at the same time. The 2.5 percent gluten and 7.5 percent flax mixture also performed well, with a cost reduction of about 2 percent and about 14 percent increase in volume. Percentages of components here are based on the total weight of whole wheat flour, gluten, flax, and water for flax.

B. The benefit of flaxseed according to the invention was tested in another experiment, which measured baked moisture content. The flax mixture is 20 weight-percent flaxseed with the remainder being room temperature water. Dry flax at 1.5 percent contains the same total flax as a 7.5 percent mixture. The results are summarized below in Table 7.

TABLE 7
Volume Increase and Baked Moisture Data

| | | % Volume | Baked % |
|---|---|---|---|
| | Volume, cc | Increase | Moisture |
| 5% gluten no flax (control) | 454 | — | 35.9 |
| 2.5% gluten, 7.5% Flax Mixture | 460 | 1.4% | 36.4 |
| 2.5% gluten, 1.5% Dry Flax | 439 | −3.4% | 35.6 |
| No Gluten, 7.5% Flax Mixture | 426 | −6.1% | 35.9 |
| 2.5% Gluten, No Flax | 429 | −5.5% | 35.2 |

Added gluten, which is required to ensure suitable texture and loaf volume in various convention bakery products, can be reduced in an amount to save on cost but at the expense of texture and volume. Surprisingly, only the 2.5 percent gluten, 7.5 percent flax mixture composition demonstrated a volume increase by substituting the flax for half of the gluten. The composition with no gluten and flax mixture decreased the most in volume, with the 2.5 percent gluten and no flax composition also losing volume. The baked moisture content in all of the composition remained substantially the same.

### Example 5

### Hardness In Baked Whole Wheat Bread

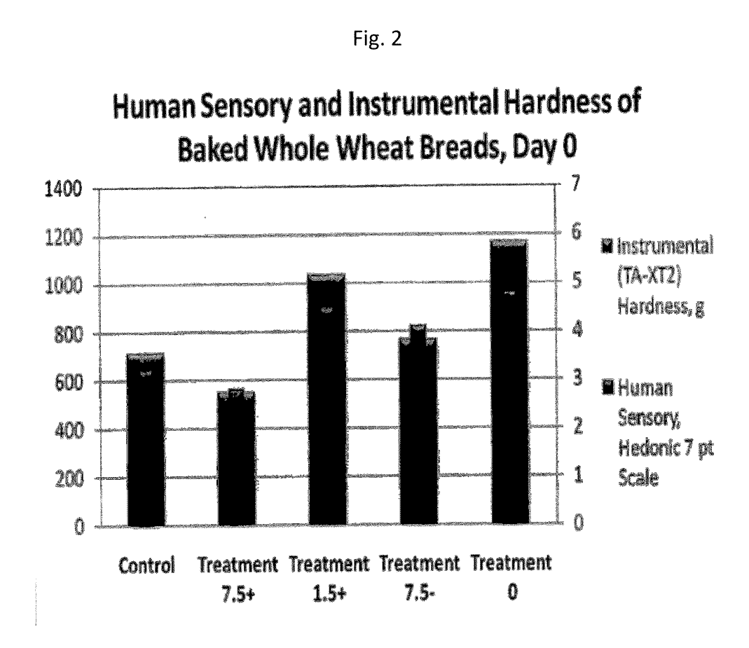

Hardness was tested for whole wheat breads made with flaxseed where the extraneous gluten component replaced was wheat gluten. In FIG. 2, 7.5+ is a composition where a 7.5 percent flaxseed mixture was added and 2.5 percent of extraneous wheat gluten is removed, 1.5+ is a composition where 1.5 percent dry flaxseed was added and 2.5 percent of extraneous wheat gluten is removed, and 7.5− is a composition that includes a 7.5 percent flaxseed mixture, but no gluten. The flax mixture is 20 weight-percent flaxseed with the remainder being room temperature water.

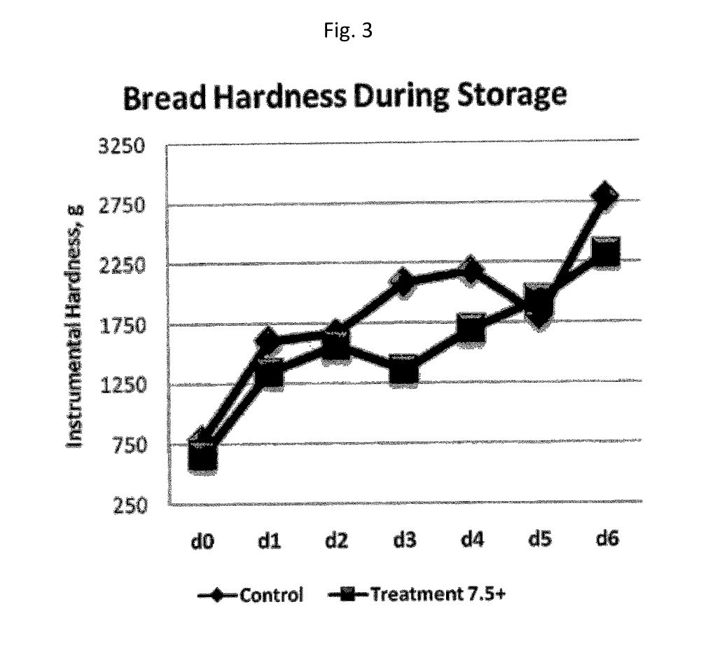

To measure the bread texture, a TA.XT2 Texture Analyzer (Texture Technologies Corp.) with XTRAD computer program was used. First, a center of a slice of bread was cut into a square 30 mm×30 mm and 20 mm thick. Next, a TA-25 probe (2″ diameter aluminum cylinder) was compressed the mm square bread sample by 70% of its original height (14 mm) at a speed of 1.7 mm/sec. This test was a two-stroke test and there was a programmed 3 second delay between strokes. FIG. 3 shows bread hardness of an embodiment of the invention over six days of storage. The bread composition treated with a 7.5 percent flaxseed mixture had the best or lowest hardness at Day 0, and its hardness remained lower than control over time. Utilization of the flax thus surprisingly produced softer bread that stayed softer over a 6-day shelf-life.

### Example 6

### Viscosity Studies

The viscosity of flax compositions were tested at different temperatures, the addition of salt, and the addition of sucrose.

A flax composition containing 13 percent flax by weight was subjected to various tests. The results are provided in Tables 8-10 below.

TABLE 8
Effect of Temperature on Viscosity
Viscosity of flax composition

| Time (min) | 25° C. | 37° C. | 95° C. |
|---|---|---|---|
| 2 | 195 | 195 | 295 |
| 3 | 335 | 205 | 505 |
| 4 | 530 | 500 | 630 |
| 5 | 650 | 605 | 785 |
| 6 | 685 | 620 | 975 |
| 7 | 770 | 750 | 1240 |
| 8 | 805 | 830 | 1320 |
| 9 | 875 | 850 | 1380 |
| 10 | 930 | 935 | 1450 |
| 11 | 955 | 955 | 1520 |
| 12 | 1030 | 960 | 1550 |
| 13 | 1050 | 980 | 1600 |
| 14 | 1100 | 1100 | 1740 |
| 15 | 1130 | 1120 | 1810 |
| 16 | 1200 | 1150 | 1900 |
| 17 | 1250 | 1170 | 1940 |

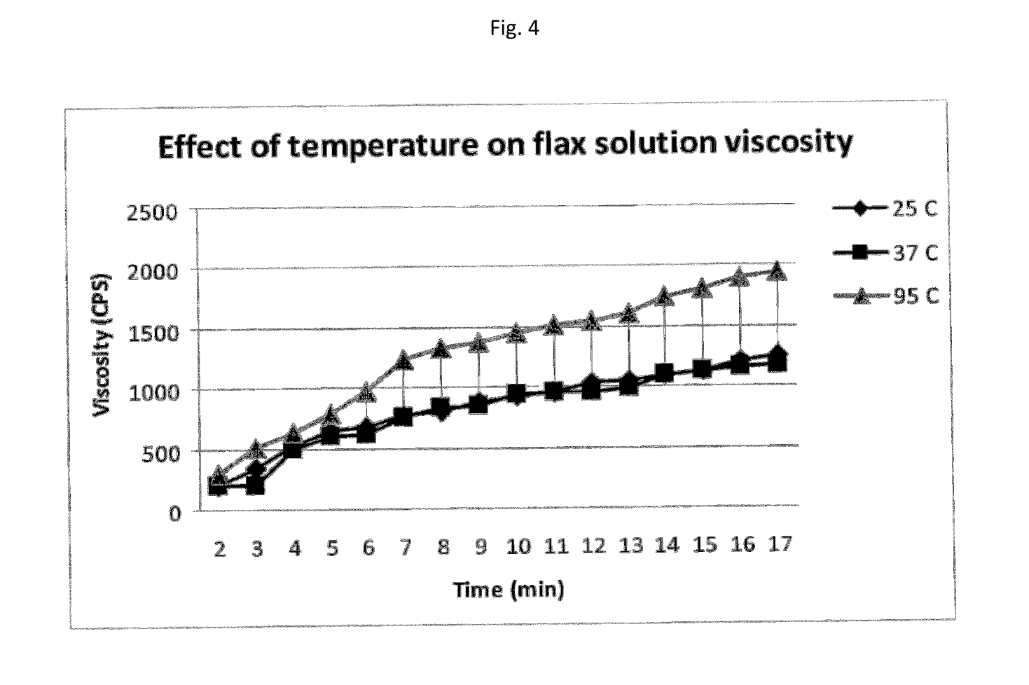

Most starches and gums have decreased viscosity as temperature is increased. As seen above, however, the viscosity of the flaxseed compositions are almost identical at 25° C. and 37° C. This surprisingly and unexpectedly helps the flaxseed compositions of the invention remain pourable and mixable longer, particularly during processing and heating of the flaxseed with other food ingredients. FIG. 4 illustrates the effect of temperature on flax solution viscosity in this embodiment.

TABLE 9
Effect of Sucrose on Viscosity
Effect of sucrose Flax: 13%

| Sucrose concentration | CPS |
|---|---|
| 0 | 1640 |
| 10% | 1250 |
| 30% | 640 |
| 50% | 430 |

TABLE 10
Effect of Salt on Viscosity
Effect of salt Flax 13%

| Salt concentration | CPS |
|---|---|
| 0 | 1640 |
| 2% | 450 |
| 5% | 310 |

As seen in Tables 9 and 10, the flax compositions surprisingly provide the best thickening effect with the least amount of salt and sucrose, which advantageously can limit or avoid the need to add these unhealthy components for reasons other than taste of the food product.

The foregoing outlines features of several embodiments so that those of ordinary skill in the art may better understand the various aspects of the present disclosure describing the invention. Those of ordinary skill in the art should appreciate that they may readily use the present disclosure as a basis for designing or modifying other food product details for carrying out the same purposes and/or achieving the same advantages of the embodiments introduced herein. Those of ordinary skill in the art should also realize that such equivalent details do not depart from the spirit and scope of the present disclosure, and that they may make various changes, substitutions and alterations herein without departing from the spirit and scope of the present disclosure.

What is claimed is:

1. A method for preparing a stable, flax-substituted food product which comprises
a) providing a plurality of flaxseeds;
b) combining a sufficient amount of an aqueous component and the plurality of flaxseeds to form a pre-hydrated flaxseed composition having a substantially uniform viscosity; and
c) preparing the stable, flax-substituted food product so as to contain a reduced amount of an extraneous gluten component by combining a plurality of different food ingredients with an amount of the pre-hydrated flaxseed composition sufficient to substitute for the amount of the extraneous gluten component.

2. The method of claim 1, wherein the at least about 50 weight percent of the extraneous gluten component is substituted.
